(19) United States
(12) Patent Application Publication
(10) Pub. No.: US 2005/0091877 A1
(43) Pub. Date: May 5, 2005

(54) Drying unit and drying process for drying a tobacco product

(75) Inventors: Dietmar Zielke, Hamburg (DE); Uwe Wenck, Hamburg (DE)

Correspondence Address: GREENBLUM & BERNSTEIN, P.L.C., 1950 ROLAND CLARKE PLACE, RESTON, VA, 20191, US

(73) Assignee: Hauni Maschinenbau AG, Hamburg (DE)

(21) Appl. No.: 10/943,006

(22) Filed: Sep. 17, 2004

(30) Foreign Application Priority Data
Sep. 19, 2003 (EP) 03 09 0308.2

(51) Int. Cl. F26B 3/08

(52) U.S. Cl. 34/528

(57) ABSTRACT

A dryer for drying a tobacco product including a drying device structured and arranged to dry the tobacco product passing through the drying device. The dryer further including a measuring device arranged to produce a measurement signal related to an input moisture of the tobacco product before the tobacco product is supplied to the drying device. Moreover, the dryer includes a controller structured to variably control a product mass stream passing through the drying device as a function of the measurement signal. The instant abstract is neither intended to define the invention disclosed in this specification nor intended to limit the scope of the invention in any way.

### CROSS-REFERENCE TO RELATED APPLICATIONS

The present application claims priority under 35 U.S.C. §119 of European Patent Application No. 03 09 0308.2, filed on Sep. 19, 2003, the disclosure of which is expressly incorporated by reference herein in its entirety.

### BACKGROUND OF THE INVENTION

1. Field of the Invention

The present invention relates to a drying unit for drying a tobacco product which comprises a drying device for drying the product that is passed through the drying device and a measuring device for producing a measurement signal related to an input moisture of the product before it is supplied to the drying device. The invention also relates to a corresponding drying process.

2. Discussion of Background Information

For varying input moisture of a tobacco product before supply to the drying device, it is known to control the drying device so that more or less water is evaporated therein, for example by regulating the evaporation temperature to maintain the output moisture constant after leaving the drying device. Since the transfer of energy in the drying device is relatively inert, maintaining the output moisture constant is not satisfactory.

It is also known to add water for evaporation to the drying device as a function of the original product moisture in order to reach a constant output moisture for constant evaporated quantity of water. This is awkward on the one hand, since devices for regulated addition of water have to be provided, and on the other hand wastes energy, since evaporation of the added water requires additional energy.

DE 33 36 632 C2 discloses a device for drying tobacco leaves, in which the speed with which the leaves are supplied, can be adjusted by manually changing a width of a supply device.

A drum evaporation device is known from EP 0 481 110 B1, in which a conveyer belt arranged in a drum can be displaced, wherein as a function of the final moisture of the product, the conveyer belt is displaced so far into the drum that the required product moisture is achieved. The residence time of the tobacco in the drier is thus changed. Displacement of the conveyer belt requires complex mechanics.

A moistening and saucing unit for a tobacco stream is known from GB 1 452 664. The unit comprises a saucing station, an input moisture measuring device and a belt weigher. A computer determines the dry mass of the tobacco from the corresponding signals. The speed of the belt weigher is controlled so that the dry mass of the tobacco supplied to the saucing station has a preset value. In order to achieve a constant output moisture, moistening nozzles are controlled within the saucing station.

### SUMMARY OF THE INVENTION

One aspect of the present invention is to provide a drying unit, in which the output moisture is reliably maintained to be constant and which is achieved using a simple apparatus and/or process.

The present invention achieves this aspect with a drying unit for drying a tobacco product which includes a drying device for drying the product that is passed through the drying device. Moreover, the present invention includes a measuring device for producing a measured signal related to the input moisture of the product before it is supplied to the drying device. The present invention further includes a control device for control of the product mass stream passed through the drying device as a function of the measured signal. The present invention further includes variable control of the product mass stream which is performed such that at higher input moisture, a lower product mass stream is passed through the drying device and vice versa.

The present invention further achieves this aspect of the invention with a drying process for drying a tobacco product. The process includes the supply of the product to a drying device and drying of the product passing through the drying device. The process further includes the producing a measured signal, related to the input moisture of the product before it is supplied to the drying device, and variably controlling of the product mass stream supplied to the drying device as a function of the measured signal such that at higher input moisture, a lower product mass stream passes through the drying device and vice versa.

In particular, the drying unit includes a control device for controlling the product mass stream passing through the drying device as a function of the measurement signal. In this manner, variable control of the product mass stream takes place such that, at higher input moisture, a lower product mass stream passes through the drying device and vice versa. The quantity of water supplied to the drying device can be controlled in a simple manner by controlling the product mass steam. At higher input moisture, a lower product mass stream passes through the drying device to maintain the output moisture and vice versa. The quantity of water evaporated per unit of time and in particular the evaporation temperature in the drying device may thus be kept constant. The problems of the state of the art associated with the inertia of energy transfer in the drying device are avoided according to the invention.

The term “mass stream” designates the mass transported per unit of time, i.e. mass flow, which is indicated, for example, in kg/hour.

The control device is not restricted to control in a narrow sense, but may also include regulation, for example the preferred regulation as a function of an output moisture measurement signal. The control device is therefore representative of a control and/or regulating device.

Control may preferably be performed by controlling of the product mass stream supplied to the drying device. This permits the use of known evaporation devices at constant transport speed. Controlling of the product mass stream passing through the drying device may be performed in a simple manner, for example by controlling an optimal conveyer belt. It may thus be, for example, a feed belt of a supply unit for supplying the product mass to the drying device. However, it is also possible that the control device acts on a transport device for the transport of the product through the drying device, so that the supplied product mass stream does not necessarily have to be changeable.

The measuring device is preferably a moisture measuring device. It may be in particular a moisture measuring device to measure the input moisture of the product before it is supplied to the drying device. However, this is not absolutely necessary. Generally, it is only necessary that the measured parameter is related to the input moisture. It may therefore also be, for example, a weighing device for measuring the product input mass, since the product input moisture fₑ is associated with the product input mass mₑ(product) as follows:
fₑ=1−[mₑ(dry product)/mₑ(product)],
wherein mₑ(dry product) designates the input mass of the dry product i.e., the product input weight increases with increasing moisture for the same volume. For example mₑ(dry product) is known approximately from the known density ρₑ of the dry product when assuming a constant volume independently of the moisture fₑ. Therefore an input moisture sensor does not necessarily have to be provided, although this is more precise and therefore advantageous.

The product output moisture is also related to the product input moisture and may be used as a measuring parameter according to the invention. Other measuring parameters, such as for example the product input density, are within the spirit and scope of the present invention. Measuring a different parameter than the product input moisture may make corresponding calibration necessary.

An output moisture measuring sensor is preferably provided to measure the output moisture of the product after leaving the drying device. This permits control of the required target parameter and regulation of the product mass stream passed through the drying device as a function of an output moisture measurement signal output by the output moisture measuring device, as a result of which higher precision can be achieved with regard to the required constant output moisture.

A weighing device is preferably provided to measure the input mass of the product before it is supplied to the drying device. This may facilitate adjustment or control of the required input product mass stream, but is not absolutely necessary.

One aspect of the invention includes a dryer for drying a tobacco product including a drying device structured and arranged to dry the tobacco product passing through the drying device. The dryer further including a measuring device arranged to produce a measurement signal related to an input moisture of the tobacco product before the tobacco product is supplied to the drying device. Moreover, the dryer includes a controller structured to variably control a product mass stream passing through the drying device as a function of the measurement signal.

A further aspect of the invention can include the dryer where at a higher input moisture, a lower product mass stream can be passed through the drying device. Moreover, at a lower input moisture, a higher mass stream can be passed through the drying device. Additionally, the product mass stream can be inversely proportional to the input moisture of the tobacco product. Moreover, the product mass stream supplied to the drying device can be controlled. Additionally, a conveying speed of a product conveyer belt can be controlled. Furthermore, the measuring device can be a moisture measuring device. Also, the measuring device can include a moisture measuring device that measures an input moisture of the tobacco product before the tobacco product is supplied to the drying device. Moreover, the dryer can include a weigher to measure an input mass of the tobacco product before the tobacco product is supplied to the drying device. Additionally, the product mass stream passing through the drying device can be controlled as a function of a measurement signal output by the weigher. Furthermore, the weigher can be structured and arranged as a belt weigher. The dryer can also include an output moisture measuring device arranged to measure an output moisture of the tobacco product after leaving the drying device. Moreover, the product mass stream passing through the drying device can be regulated as a function of a measurement signal output by the output moisture measuring device. Additionally, the product mass stream passing through the drying device can be controlled in indirect proportion to a difference between the input moisture and a nominal value of an output moisture.

Another aspect of the invention includes a drying process for drying a tobacco product. The process includes supplying a product mass stream of the tobacco product to a drying device. The process further includes drying the tobacco product passing through the drying device. Additionally, the process includes generating a signal related to an input moisture of the tobacco product before being supplied to the drying device and variably controlling the product mass stream supplied to the drying device in accordance with the generated signal.

A further aspect of the invention includes the drying process where when the tobacco product has a higher input moisture, a lower product mass stream can be passed through the drying device. Moreover, when the tobacco product has a lower input moisture, a higher product mass stream can be passed through the drying device. Additionally, the product mass stream can be inversely proportional to the input moisture of the tobacco product. Furthermore, a dryer for drying a tobacco product can use the above-noted process.

Yet another aspect of the invention includes a dryer for drying a tobacco product. The dryer including a drying device that dries the tobacco product and a measurer that measures a moisture content of the tobacco product before drying. Moreover, the dryer includes a variable controller that variably controls a product mass stream that is passed through the drying device based upon the measured moisture content.

Further aspects of the invention can include the dryer having a product conveyer belt and the dryer can be structured and arranged to control a conveying speed of the product conveyer belt. Additionally, the measurer can be a moisture measuring device. Moreover, the dryer can include a weigher to measure a mass of the tobacco product before the tobacco product is supplied to the drying device. Furthermore, the dryer can be structured and arranged to control the product mass stream that is sent to the drying device as a function of a measurement signal output by the weigher. Moreover, the weigher can be structured and arranged as a belt weigher. The dryer can further include an output moisture measurer that measures a moisture content of the tobacco product after leaving the drying device. Additionally, the dryer can be structured and arranged to regulate the product mass stream that is passed through the drying device as a function of a measurement signal output by the output moisture measurer.

Another aspect of the invention includes a drying process for drying a tobacco product that is supplied to a drying device and passed through the drying device. The process includes measuring a moisture content of the tobacco product and variably controlling a product mass stream supplied to the drying device as a function of the moisture content.

A further aspect of the invention can include measuring moisture content of the tobacco product before being supplied to the drying device. Moreover measuring moisture content of the tobacco product can take place after being supplied to the drying device. Additionally, the process can include controlling the product mass stream supplied to the drying device such that at a higher moisture content, a lower product mass stream can be passed through the drying device, and at a lower moisture content, a higher product mass stream can be passed through the drying device. Additionally, the product mass stream can be inversely proportional to the input moisture of the tobacco product. Furthermore, as the tobacco product moisture increases, the tobacco product stream can decrease. Moreover, as the tobacco product moisture decreases, the tobacco product stream can increase.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a schematic view of a drying unit;

FIG. 2 shows a schematic view of a further drying unit;

FIG. 3 shows a schematic view of a third drying unit; and

FIG. 4 shows a schematic representation of various drying processes.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The tobacco product 11 to be dried is supplied in the arrow direction by the use of a supply unit, which includes a feed belt 10. At a terminating end of the feed belt 10, the product 11 is supplied to a drying device 13. In the drying device 13, heating devices, not shown, effect heating of the product 11 passed through the drying device 13 in order to effect evaporation of water present in the product 11 and hence drying of the product 11. After leaving the drying device 13, the dried product is supplied to subsequent processing stages by use of a further conveyer belt 18.

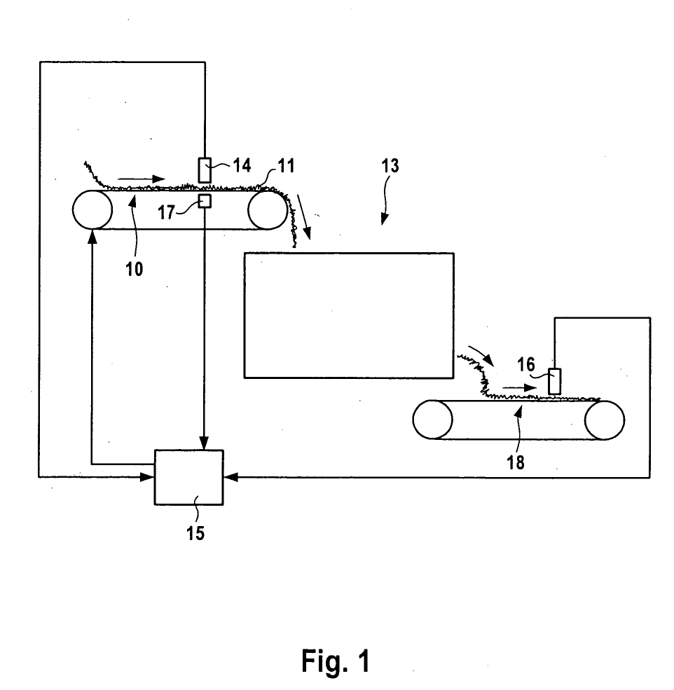

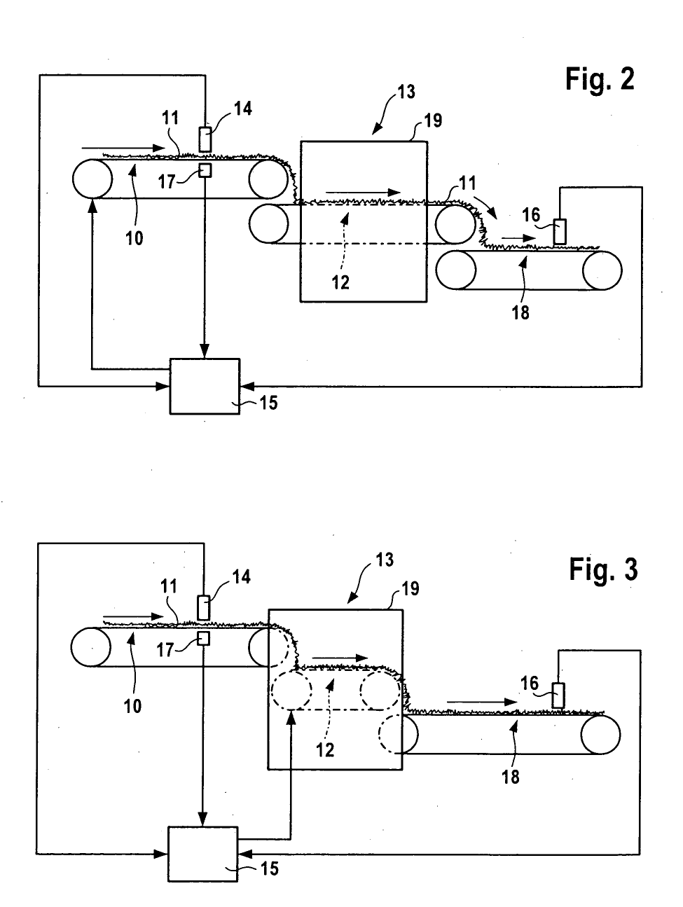

The drying device 13 from FIG. 1 may be, for example, a steam drier, a drum drier, a turbulent layer drier or a different drier familiar to the those ordinary skilled in the art. In the case of FIGS. 2 and 3, the drying device 13 comprises an evaporation chamber 19, wherein the product 11 is passed through the evaporation chamber 19 by use of a transport device, which is designed here as a conveyer belt 12. In other embodiments, the product may be whirled and/or transported by an energy-transferring medium, for example hot gas. Separate conveying devices in the drying device 13 are therefore not absolutely necessary.

The input moisture of the product 11 is determined by use of the input moisture sensor 14 and a corresponding product input moisture signal fₑ transmitted to a control device 15. The output moisture fₐ of the product 11 is determined by use of the output moisture sensor 16 and a corresponding product output moisture signal transmitted to the control device 15. The input mass me of the product 11 is determined by use of the weighing device 17 and a corresponding product input mass signal transmitted to the control device 15.

The control device 15 controls the product mass stream passed through the drying device 13 as a function of at least one of the measurement signals fₑ, fₐ, mₑ with the aim of keeping the product output moisture fₐ constant. For this purpose, in the exemplary embodiments shown in FIGS. 1 and 2, the supply device is controlled in order to regulate the product input mass stream supplied to the drying device 13. This may be performed, for example, by control of the conveying speed of the feed belt 10, as shown in FIGS. 1 and 2. The mass stream m/Δt to be set and to be passed through the drying device 13 can be determined approximately by the following relationship:
m/Δt=mᵥ(H₂O)/Δt·[(1−fₐ*)/(fₑ−fₐ*)].
Therein, mᵥ(H₂O)/Δt designates the mass of water evaporated per unit of time in the drying device 13 and fₐ* the desired output moisture (nominal value). If the evaporation parameters, that is, the evaporation temperature, and the heating capacity are advantageously kept constant, the quantity of water mᵥ(H₂O)/Δt evaporated per unit of time in the drying device 13 is approximately constant and approximately not dependent on the quantity or transport speed of the product passed though the evaporation chamber. By using the measurement parameter fₑ in the above formula, the mass stream m/Δt through the drying device 13 to be set may then be determined by use of the above formula. Control is performed in the examples of FIGS. 1 and 2 by changing the supply speed of the feed belt 10, until the input mass signal mₑ, measured by the weighing device for the transport interval Δt covered by the weighing device, is in agreement with the nominal value determined by use of the above formula. In FIGS. 1 and 2, the mass stream m/Δt through the drying device 13 is therefore changed by a corresponding change of the product input mass stream mₑ/Δt.

The weighing device 17 for measuring the input mass signal may be, for example, a belt weigher, for example in a unit with the feed belt 10. Other embodiments, for example an impact plate scale, are possible. The integration distance of the weighing device 17, that is, the measuring distance covered in the measuring process, is preferably as low as possible to improve the precision. The scale 17 and/or the input moisture sensor 14 are preferably arranged as close as possible to the drying device 13 for the same reasons in order to facilitate as contemporary control as possible or so that changes on the path between the particular measuring apparatus and the drying device 13 and other comparable sources of error have as little as possible influence.

Measurement, for example of the input moisture fₑ suffices in principle in order to be able to carry out control of the product mass stream passed through the drying device 13 as a function of the corresponding measurement signal to achieve a constant output moisture. The output moisture fₐ (actual value) is preferably determined by a measuring device in order to be able to carry out a correction or an adjustment of this target parameter with the nominal parameter fₐ*. This may be achieved, for example, by inserting a correction factor fₐ*/fₐ in the above formula. For example, the energy consumption required for heating of the tobacco may thus be compensated.

Instead of the input moisture fₑ, a different measuring parameter, such as for example the output moisture fₐ or the product input mass mₑ, may also serve as a basis for control. Thus, measurement of the input moisture is then not absolutely necessary.

In the example of FIGS. 1 to 3, determination of the product input mass me by a measuring device may also be dispensed with. In this case, the supply speed to be set may be either calculated or determined in particular by use of a stored calibration curve. Calibration of the supply speed may therefore possibly be necessary for various values of the corresponding measurement signal. Generally, parameters not measured may, for example, be calculated or determined by use of stored calibration curves. For example, calibration of the product mass stream to be passed through the drying device 13 may be necessary for various values of the corresponding measurement signal.

In the exemplary embodiment of FIG. 3, the transport speed, at which the product is passed through the drying device 13, is changed. This is performed, for example, by control of a chamber conveyer belt 12, which may be contained in the drying device 13 completely as shown in FIG. 3 or partly as shown in FIG. 2. However, this is not absolutely necessary, control may also be performed without separate conveying devices in the drying device 13. In a further embodiment, for example in FIG. 2, the conveyer belt speed of the conveyer belt 12 may be controlled to control the product mass stream conveyed through the drying device 13.

Instead of the three conveyer belts 10, 12 and 18 shown in FIGS. 2 and 3, a single continuous conveyer belt may also be provided.

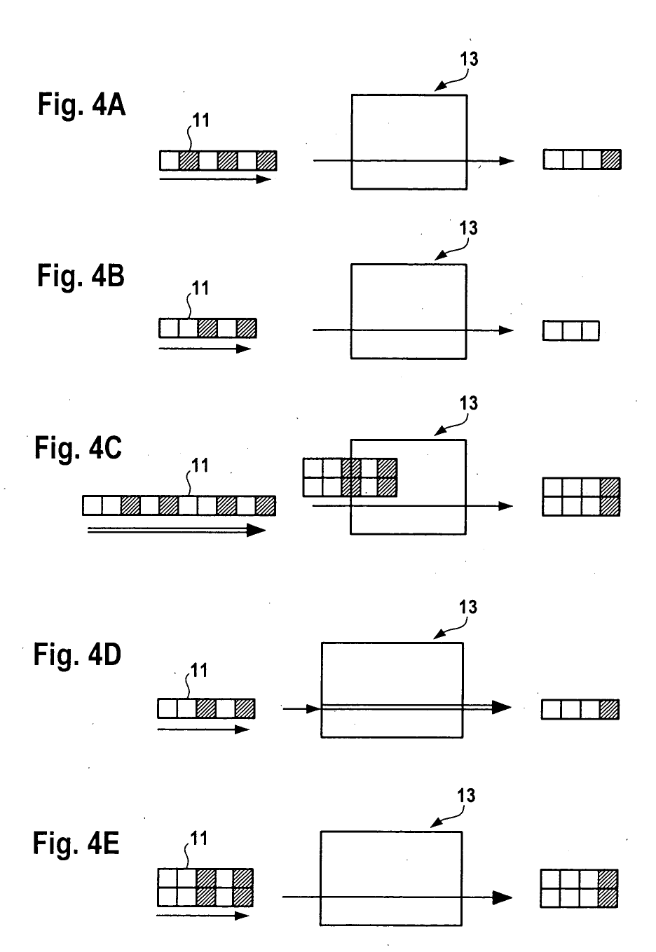

Control of the product mass stream conveyed through the drying device 13 may be illustrated using FIGS. 4A-4E. In FIG. 4A, the product 11 supplied to the drying device 13 has an input moisture of 50%. This is explained graphically in that alternately a dry product mass unit (an empty box) and a water mass unit (a hatched box) are drawn. For the sake of simplicity, it may be assumed that a box corresponds to a mass of 1 kg. The evaporation temperature, the evaporation capacity and other evaporation parameters of the drying device 13 may thus be set and kept constant so that 2 kg of water are evaporated in the drying device 13 per second. This is a property of the drying device 13 independently of the moisture and transport speed of the product passed through the drying device 13. In FIG. 4A, for example the moist product is supplied at an input mass stream of 6 kg/second and passed through the drying device 13, wherein it may reside for 1 second in the drying device 13 due to the set transport speed. This leads to evaporation of 2 kg of water, so that the output moisture of the product is 25% (1 kg of water for 3 kg of dry product, see FIG. 4A). It may be assumed that this corresponds to the desired output moisture.

It may now be assumed that the input moisture, as shown in FIG. 4B, change to 40% due to an input moisture variation (2 kg of water for 3 kg of dry product). Without further measures with otherwise unchanged conditions, 2 kg of water/second would then be evaporated, so that the output moisture would be about 0% as shown. An input moisture fₑ of 40% is measured by use of the input moisture sensor 14. Using this value in the above formula where mᵥ(H₂O)/Δt=2 kg/second and fₐ*=0.25 gives for the mass stream to be set and to be conveyed through the evaporation chamber m/Δt=mᵥ(H₂O)/Δt·[(1−fₐ*)/(fₑ−fₐ*)]=10 kg/second. The control device 15 therefore controls the product mass stream passed through the drying device 13 at 10 kg/second.

This may be performed in a different manner. For example, as in the examples of FIGS. 4C and 4E, the input mass stream may be doubled from 5 kg/second to 10 kg/second. This may be achieved, for example as in the example of FIG. 4C, by doubling the supply speed, as indicated by the double arrow. In the example of FIG. 4C, the transport speed through the drying device 13 remains unchanged compared to the previous state shown in FIG. 4B. Since the product therefore remains unchanged for 1 second in the drying device 13, and thus 2 kg of water are evaporated, the product leaves the drying device 13 at 8 kg/second and the desired moisture of 25% (see FIG. 4C).

In the example of FIG. 4E, the supply speed remains unchanged, but the mass coverage of the feed belt per belt distance is doubled. The result is the same as shown in FIG. 4C.

In the example of FIG. 4D, the input mass stream remains unchanged, but the transport speed through the drying device 13 is doubled. Now the product remains for only ½ second in the drying device 13. In this period of time, only 1 kg of water is evaporated in the drying device 13. As a result, the product leaves the drying device 13 at 4 kg/second and the required moisture of 25% (see FIG. 4D).

Intermediate forms of all types between the examples of FIGS. 4C, 4D and 4E are possible. For example, the product may be fed at 8 kg/second and conveyed at a speed through the drying device 13 which is increased by 25%. However, the embodiments in which the transport speed through the drying device 13 remains constant at any time (for example FIGS. 4C, 4E), are preferred with respect to the embodiments for which this is not true (for example FIG. 4D), since this permits the use of known evaporation devices at constant transport speed.

In the case of a continuous conveyer belt, an increase in conveyer belt speed by a factor √2 (general factor √n) would be advantageous in order to achieve doubling (generally increase by a factor n) of the product mass stream passed through the drying device 13.

For example it can be seen by comparing FIGS. 4A and 4B that the product input mass stream changes by itself for varying input moisture. In contrast thereto, the actively controlled change of product input mass stream by use of the control device 15, for example as shown in FIGS. 4C and 4E.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A dryer for drying a tobacco product comprising:
a drying device structured and arranged to dry the tobacco product passing through the drying device;
a measuring device arranged to produce a measurement signal related to an input moisture of the tobacco product before the tobacco product is supplied to the drying device;
a controller structured to variably control a product mass stream passing through the drying device as a function of the measurement signal.

2. The dryer according to claim 1, wherein at a higher input moisture, a lower product mass stream is passed through the drying device.

3. The dryer according to claim 2, wherein at a lower input moisture, a higher mass stream is passed through the drying device.

4. The drying process according to claim 1 wherein the product mass stream is inversely proportional to the input moisture of the tobacco product.

5. The dryer according to claim 1, wherein the product mass stream supplied to the drying device is controlled.

6. The dryer according to claim 1 wherein a conveying speed of a product conveyer belt is controlled.

7. The dryer according to claim 1 wherein the measuring device is a moisture measuring device.

8. The dryer according to claim 1, wherein the measuring device comprises a moisture measuring device that measures an input moisture of the tobacco product before the tobacco product is supplied to the drying device.

9. The dryer according to claim 1, further comprising:
a weigher to measure an input mass of the tobacco product before the tobacco product is supplied to the drying device.

10. The dryer according to claim 9, wherein the product mass stream passing through the drying device is controlled as a function of a measurement signal output by the weigher.

11. The dryer according to claim 9, wherein the weigher is structured and arranged as a belt weigher.

12. The dryer according to claim 1, further comprising:
an output moisture measuring device arranged to measure an output moisture of the tobacco product after leaving the drying device.

13. The dryer according to claim 9, wherein the product mass stream passing through the drying device is regulated as a function of a measurement signal output by the output moisture measuring device.

14. The dryer according to claim 1, wherein the product mass stream passing through the drying device is controlled in indirect proportion to a difference between the input moisture and a nominal value of an output moisture.

15. A drying process for drying a tobacco product comprising:
supplying a product mass stream of the tobacco product to a drying device;
drying the tobacco product passing through the drying device;
generating a signal related to an input moisture of the tobacco product before being supplied to the drying device; and
variably controlling the product mass stream supplied to the drying device in accordance with the generated signal.

16. The drying process according to claim 15 wherein when the tobacco product has a higher input moisture, a lower product mass stream is passed through the drying device.

17. The drying process according to claim 16 wherein when the tobacco product has a lower input moisture, a higher product mass stream is passed through the drying device.

18. The drying process according to claim 15 wherein the product mass stream is inversely proportional to the input moisture of the tobacco product.

19. A dryer for drying a tobacco product using the process of claim 15.

20. A dryer for drying a tobacco product comprising:
a drying device that dries the tobacco product;
a measurer that measures a moisture content of the tobacco product before drying; and
a variable controller that variably controls a product mass stream that is passed through the drying device based upon the measured moisture content.

21. The dryer according to claim 20 further comprising:
a product conveyer belt,
wherein the dryer is structured and arranged to control a conveying speed of the product conveyer belt.

22. The dryer according to claim 20 wherein the measurer is a moisture measuring device.

23. The dryer according to claim 20, further comprises:
a weigher to measure a mass of the tobacco product before the tobacco product is supplied to the drying device.

24. The dryer according to claim 23, wherein the dryer is structured and arranged to control the product mass stream that is sent to the drying device as a function of a measurement signal output by the weigher.

25. The dryer according to claim 23, wherein the weigher is structured and arranged as a belt weigher.

26. The dryer according to claim 20, wherein the dryer further comprises:
an output moisture measurer that measures a moisture content of the tobacco product after leaving the drying device.

27. The dryer according to claim 20, wherein the dryer is structured and arranged to regulate the product mass stream that is passed through the drying device as a function of a measurement signal output by the output moisture measurer.

28. A drying process for drying a tobacco product that is supplied to a drying device and passed through the drying device, comprising:
measuring a moisture content of the tobacco product;
variably controlling a product mass stream supplied to the drying device as a function of the moisture content.

29. The process according to claim 28 wherein the measuring comprises measuring moisture content of the tobacco product before being supplied to the drying device.

30. The process according to claim 28 wherein the measuring comprises measuring moisture content of the tobacco product after being supplied to the drying device.

31. The process according to claim 28 wherein the controlling comprises controlling the product mass stream supplied to the drying device such that at a higher moisture content, a lower product mass stream is passed through the drying device, and at a lower moisture content, a higher product mass stream is passed through the drying device

32. The process according to claim 28 wherein the product mass stream is inversely proportional to the input moisture of the tobacco product.

33. The process according to claim 28 wherein as the tobacco product moisture increases, the tobacco product stream decreases.

34. The process according to claim 33 wherein as the tobacco product moisture decreases, the tobacco product stream increases.
